(19) United States
(12) Patent Application Publication
(10) Pub. No.: US 2025/0298592 A1
(43) Pub. Date: Sep. 25, 2025

(54) GENERATING SOLUTION OPTIMIZATION MODELS FROM SOLUTION VERIFICATION CODE

(71) Applicant: INTERNATIONAL BUSINESS MACHINES CORPORATION, ARMONK, NY (US)

(72) Inventor: Eliezer Segev Wasserkrug, Haifa (IL)

(21) Appl. No.: 18/613,822

(22) Filed: Mar. 22, 2024

(51) Int. Cl. G06F 8/41

(52) U.S. Cl. CPC G06F 8/443

(57) ABSTRACT

An approach for generating optimization solutions may be presented herein. The approach may include generating an optimization solution verification program. The optimization solution verification program code can be automatically converted into a loss function, where the objection function constraints associated with the optimization solution verification program are incorporated into the loss function. A plurality of random inputs for the optimization issue can be generated and used to train a sequence generation model, based on the generated loss function. An optimized solution can be generated with the trained sequence generation model.

### BACKGROUND

The present invention relates to machine learning, and more specifically, to generating decision optimization models based on decision solution verification programs.

Optimization issue exist in nearly every aspect of modern life. Optimizing nearly any issue requires identification of constraints in which decisions must be made. Decision variables or constrained values are the unknowns of optimization issues and have a domain of values associated with them. Constraints are the limits to the combination of values for the decision variables. The end goal of a decision optimization issue revolves around an objective. The objective with respect to quantifiable optimization issues is typically an equation or expression that can be minimized or maximized. In the optimization process, one is attempting to discover a value for each decision variables while satisfying the constraints of the issue and maximizing or minimizing the objective function.

### SUMMARY

Embodiment of the present invention may be a computer-implemented method, a computer system, and/or a computer program product for generating optimization solutions. The embodiments may include generating an optimization solution verification program, wherein the optimization solution verification program determines if an input satisfies one or more constraints associated with an optimization issue and responsive to the input satisfying the one or more constraints, calculate a value for the input associated with an objective function based on the one or more constraints. Further, embodiments may include converting a program code of the optimization solution verification program into a loss function incorporating the objective function calculation and constraint satisfaction. Additionally, embodiments may include generating a plurality of random inputs to the optimization issue. Further yet, embodiments may include, training a sequence generation model with the loss function and the plurality of random inputs. Embodiments may also include, generating an optimized solution for the optimization issue based on the trained sequence generation model.

Other embodiments can include updating the program code with one or more additional constraints and/or updated objectives and updating the loss function and retraining the model.

Additional embodiments may include labeling second set of random solution, based on the updated program code. Further tuning the sequence generation model based on the labeled second set of random solutions.

In an embodiment, the generated optimized solution for the optimization issue is a set of decision variable values, where the decision variable values provide an optimized objective value when applied to the objective function within a domain space for the optimization issue, and in which these inputs and solutions generated by the optimized value and satisfying the constraints are used to tune the sequence generation model in a supervised manner.

In an embodiment, the optimization solution verification program is based on python programming language code.

In an embodiment, the optimization solution verification program is a spreadsheet based program configured to receive one or more values of the decision variables of the optimization issue as input.

In an embodiment, the sequence generation module is a transformer based deep learning network.

It should be understood, the above summary is non limiting, as it is not intended to describe each illustrated embodiment of every implementation of the present disclosure. Rather, numerous embodiments can be derived within the scope and spirit of the present disclosure.

### BRIEF DESCRIPTION OF THE DRAWINGS

FIG. 1 is a block diagram of a data processing environment capable of implementing the approach described herein, according to an embodiment of the invention.

FIG. 2 is a block diagram depicting an extension of the data processing environment compatible with the data processing environment of FIG. 1 highlighting artificial intelligence and machine learning capabilities, in accordance with an embodiment of the invention.

FIG. 3 is a block diagram depicting component architecture for generating an optimization solution to an optimization problem, in accordance with an embodiment of the invention.

FIG. 4 is a flowchart depicting steps to generate an optimization solution for an objective of an optimization problem, in accordance with an embodiment of the invention.

FIG. 5 is a flowchart depicting steps to fine-tune a trained decision generation model in response to updated constraints in an optimization issue, in accordance with an embodiment of the invention.

### DETAILED DESCRIPTION

Writing a decision optimization specification for optimization engines relies upon extensive and specialized knowledge only found in subject matter experts (i.e., “optimization engine experts”). The decision optimization specifications can be written in domain-specific languages such as OPL (Optimization Programming Language) or the Python-embedded docplex (DOcplex is a native Python modeling library for optimization). In addition to knowledge of the programming language, optimization experts require a high level of understanding of the algorithms that the optimization engine applies to a decision optimization specifications. This knowledge is required to ultimately, generate specifications that the optimization engine can use to efficiently find a solution.

Optimization experts that are able to write decision optimization specifications are scarce, while matters requiring optimization (i.e., “optimization issues”) are constantly arising and developing. Optimization issues can be a problem, issue, or condition in which decisions or actions can be implemented that result in more efficient utilization of resources (e.g., fuel, labor, costs, land, electricity, water, computational components, etc. . . . ) or time. As non-limiting examples may include, logistics route networks, merchandise supply centers, crop rotation, water utilization, computational task and location scheduling to name a few. Due to the limited capability of human experts to optimize matters that exist or arise, most optimization matters are resolved in a sub-optimal manner. Other optimization matters may be solved heuristically by custom tools providing sub-optimal results.

Developers may write software programs which verify a given solution determine if a solution conform to constraints of the matter, and if an objective is satisfied. Writing programs which verify a solution to a matter is similar to typical programming tasks. Further, it is not difficult to identify discrepancies between an intended formula and the actual formula of the matter to be optimized problem. For example, an optimization solution to a matter that is currently utilized can be input into the solution verification code to determine whether the results conform to current expectations and/or results. That being said, embodiments disclosed herein recognize that an approach for developing optimization solution validation code for optimization matters would be advantageous.

In addition to the difficulties writing a decision optimization specification for an optimization matter when or if new constraints or objectives are added to the matter, the optimization model must be reevaluated and tuned for efficiency. Sequence models which recognize datapoints and predict outcomes based on those datapoints are an efficient means to generate predictions which can be used in optimization matters. It would be advantageous to devise an approach to develop machine learning models which can output an efficient optimization decision solution in response to an optimization issue input. Embodiments disclosed herein recognize an approach for generating/training/developing a sequence generating model which can produce an optimized decision solution for an optimization matter.

In an embodiment of the invention, a solution verification program for an optimization matter maybe generated from descriptive materials associated with the optimization matter. The solution verification program can be developed by a human programmer generated by a generative artificial intelligence model, or a human may edit a generated verification program in light of the optimization issue to be addressed. The optimization matter may include multiple constraints and an objective function. In another embodiment, the solution verification program may be developed by a user (e.g., a business analyst, software engineer, program manager, etc.) using spreadsheet tools (e.g., Microsoft Excel, Google sheets, etc.).

An objective function is a function providing a value in light of the constraints. A value calculated may or may not satisfy the overall objective (i.e., a minimum value for a resource or time which the approach is attempting to optimize). Solution verification code can be generated which can analyze potential solutions in a mathematical representation format based on the objective function and the constraints and determine if a potential solution to the optimization matter optimizes the objective while satisfying the constraints.

In an embodiment, a random input generator can create or generate random inputs to the optimization matter in a numerical format. The inputs can be fed into the solution validation code to determine if the potential solution satisfies the objective of the optimization matter within the constraints. Further, the potential solutions can be labelled as valid or invalid. The potential solutions can be collected and organized into a dataset.

In an embodiment, the labeled solutions can be utilized to train or fine-tune a pre-trained decision solution generation sequence model. The decision solution sequence model can be a machine learning model that receives the objective of an optimization as input and provides iteratively, a value for each decision variable as output, where the decision variables satisfy the constraints of the optimization issue and provide a minimum or maximum value for the objective.

In an embodiment, the decision solution model can be an untrained transformer based deep learning network. In another example, a decision model generation engine can analyze the training data generated and create a decision solution model suited to the optimization issue with transformer architecture and/or attention mechanism(s) corresponding to the specifics of the optimization issue. In another example, the decision model generation engine may select a decision solution model trained to address a similar optimization issue and fine-tune the decision solution model with the generated training data.

In other words, the decision solution model receives the relationships of the optimization issue from the solution verification program. In effect machine learning models, such as the one disclosed can replace approaches in which a mathematical model (which may or may not provide an efficient optimization of the issue at hand) is generated from scratch, which requires specialized training and time. Further, these relationships are embodied within the solution verification program and exhibited though the labeled randomly generate solutions as vectors of the relationship. The labeled data is then used to automatically transform the loss function and constraints of the optimization issue into a model which outputs an optimum solution for the optimization problem based on the objectives of the optimization issue.

As disclosed herein the embodiments of the present invention may involve an approach for obtaining good (i.e., optimized) solutions to combinatorial optimization issues with automatically trained transformer-based networks and verification code. Embodiments of the present invention may also involve an approach for automatically fine-tuning a transformer based deep learning network (or any artificial intelligence model that can iteratively generate a solution to the combinatorial optimization problem) to incorporate new constraints. Additionally, embodiments of the present invention may involve an approach to automatically create or generate a transformer-based deep learning network for combinatorial optimization from an existing optimization formalism (i.e., model).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

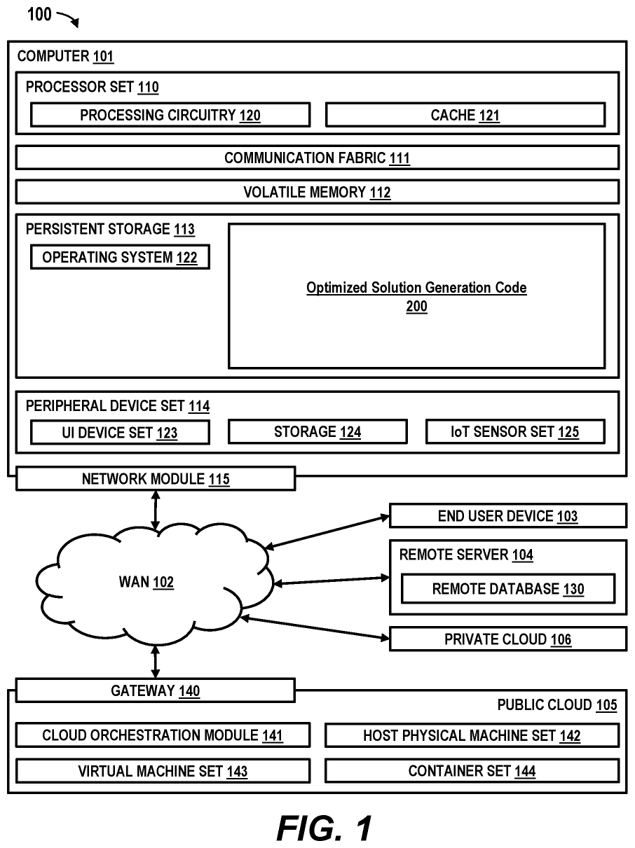

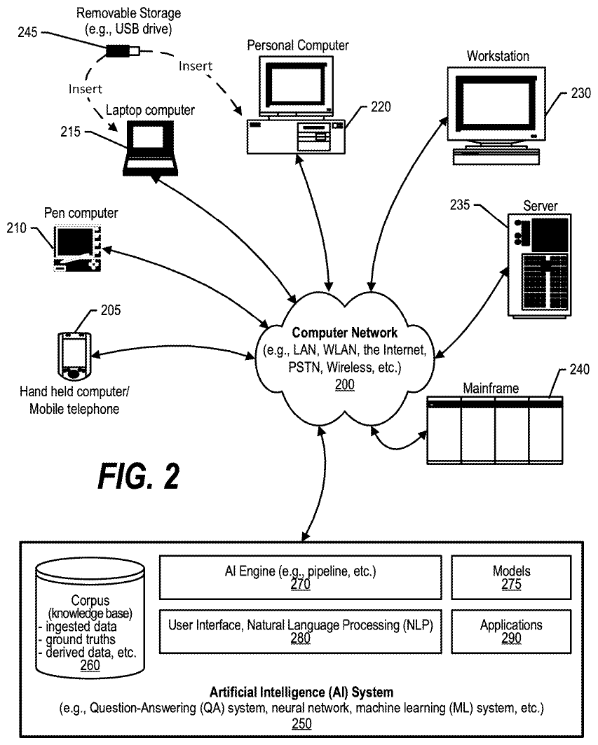

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment, highlighting artificial intelligence/machine learning capabilities, is illustrated in FIG. 2 as an extension of the data processing environment of FIG. 1, to emphasize that modern computing techniques can be performed across multiple discrete devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 is a block diagram of a data processing system in which the methods described herein can be implemented. Computing environment 100 contains an example of an environment for the execution of at least some of the computer code involved in performing the inventive methods, such as shown in the description of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A NETWORKED ENVIRONMENT is shown in FIG. 2. The networked environment provides an extension of the information handling system shown in FIG. 1 illustrating that the methods described herein can be performed on a wide variety of information handling systems that operate in a networked environment, depicted by computer network 200. Types of computer networks can include local area networks (LANs), wide area networks (WANs), the Internet, peer-to-peer networks, public switched telephone networks (PSTNs), wireless networks, etc. Types of information handling systems range from small handheld devices, such as handheld computer/mobile telephone 205 to large mainframe systems, such as mainframe computer 240. Examples of handheld computer 205 include smart phones, personal digital assistants (PDAs), personal entertainment devices, such as MP3 players, portable televisions, and compact disc players. Other examples of information handling systems include pen, or tablet, computer 210, laptop, or notebook, computer 215, personal computer 220, workstation 230, and server computer system 235. Other types of information handling systems that are not individually shown in FIG. 2 can also be interconnected other computer systems via computer network 200.

Many of the information handling systems include nonvolatile data stores, such as hard drives and/or nonvolatile memory depicted in FIG. 1. These nonvolatile data stores and/or memory can be included, or integrated, with a particular computer system or can be an external storage device, such as an external hard drive. In addition, removable nonvolatile storage device 245 can be shared among two or more information handling systems using various techniques, such as connecting the removable nonvolatile storage device 245 to a USB port or other connector of the information handling systems.

An ARTIFICIAL INTELLIGENCE (AI) SYSTEM is depicted at the bottom of FIG. 2. Artificial intelligence (AI) system 250 is shown connected to computer network 200 so that it is accessible by other computer systems 205 through 240. AI system 250 runs on one or more information handling systems (comprising one or more processors and one or more memories, and potentially any other computing device elements generally known in the art including buses, storage devices, communication interfaces, and the like) that connects AI system 250 to computer network 200. The network 200 may include multiple computing devices 104 in communication with each other and with other devices or components via one or more wired and/or wireless data communication links, where each communication link may comprise one or more of wires, routers, switches, transmitters, receivers, or the like. AI system 250 and network 200 may enable functionality, such as question/answer (QA) generation functionality, for one or more content users. Other embodiments of AI system 250 may be used with components, systems, sub-systems, and/or devices other than those that are depicted herein.

AI system 250 maintains corpus 260, also known as a “knowledge base,” which is a store of information or data that the AI system draws on to solve problems. This knowledge base includes underlying sets of facts, ground truths, assumptions, models, derived data, and rules which the AI system has available in order to solve problems. In one embodiment, a content creator creates content in corpus 260. This content may include any file, text, article, or source of data for use in AI system 250. Content users may access AI system 250 via a network connection or an Internet connection to the network 200, and, in one embodiment, may input questions to AI system 250 that may be answered by the content in the corpus of data. As further described below, when a process evaluates a given section of a document for semantic content, the process can use a variety of conventions to query it from the AI system.

AI system 250 may be configured to receive inputs from various sources. For example, AI system 250 may receive input from the network 200, a corpus of electronic documents or other data, a content creator, content users, and other possible sources of input. In one embodiment, some or all of the inputs to AI system 250 may be routed through the network 200. The various computing devices on the network 200 may include access points for content creators and content users. Some of the computing devices may include devices for a database storing the corpus of data. The network 200 may include local network connections and remote connections in various embodiments, such that AI system 250 may operate in environments of any size, including local and global, e.g., the Internet. Additionally, AI system 250 serves as a front-end system that can make available a variety of knowledge extracted from or represented in documents, network-accessible sources and/or structured data sources. In this manner, some processes populate the AI system with the AI system also including input interfaces to receive knowledge requests and respond accordingly.

AI Engine 270, such as a pipeline, is an interconnected and streamlined collection of operations. The information works its way into and through a machine learning system, from data collection to training models. During data collection, such as data ingestion, data is transported from multiple sources, such as sources found on the Internet, into a centralized database stored in corpus 260. The AI system can then access, analyze, and use the data stored in its corpus.

Models 275 are the result of AI modeling. AI modeling is the creation, training, and deployment of machine learning algorithms that emulate logical decision-making based on the data available in the corpus with the system sometimes utilizing additional data found outside the corpus. AI models 275 provide AI system 250 with the foundation to support advanced intelligence methodologies, such as real-time analytics, predictive analytics, and augmented analytics.

User interface 280, such as Natural Language (NL) Processing (NLP) is the interface provided between AI system 200 and human uses. Semantic content is content based on the relation between signifiers, such as words, phrases, signs, and symbols, and what they stand for, their denotation, or connotation. In other words, semantic content is content that interprets an expression, such as by using NLP. Semantic data is stored as part of corpus 260. In one embodiment, the process sends well-formed questions (e.g., natural language questions, etc.) to the AI system. AI system 250 may interpret the question and provide a response to the content user containing one or more answers to the question. In some embodiments, AI system 250 may provide a response to users in a ranked list of answers. Other types of user interfaces (UIs) can also be used with AI system 250, such as a command line interface, a menu-driven interface, a Graphical User Interface (GUI), a Touchscreen Graphical User Interface (Touchscreen GUI), and the like.

AI applications 290 are various types of AI-centric applications focused on one or more tasks, operations, or environments. Examples of different types of AI applications include search engines, recommendation systems, virtual assistants, language translators, facial recognition and image labeling systems, and question-answering (QA) systems.

In some illustrative embodiments, AI system 250 may be a question/answering (QA) system, which is augmented with the mechanisms of the illustrative embodiments described hereafter. A QA type of AI system 250 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the I QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

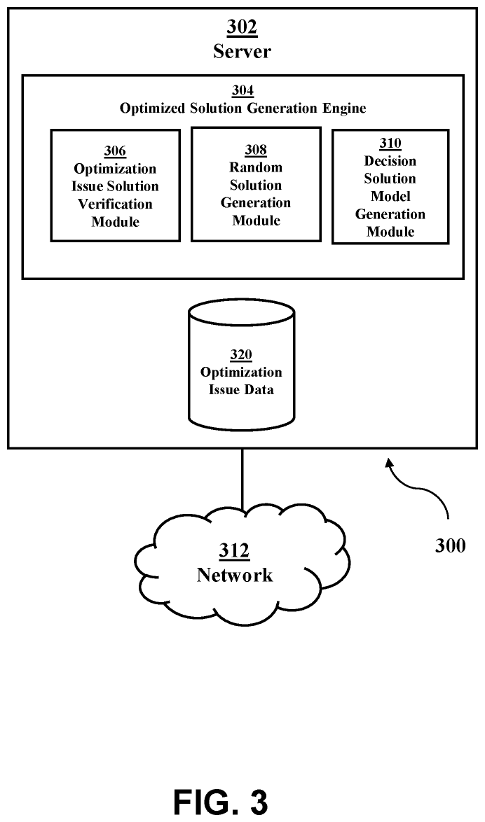

Now with reference to FIG. 3. FIG. 3 is exemplary environment 300 for creating decision solution optimization models trained to generate optimized solutions to optimization issues. Shown in exemplary environment 300 is server 302. Server 302 is analogous to computer 101 of FIG. 1 in architecture and capabilities. Shown operational on server 302 is optimized solution generation engine 304. Optimization issue data 320 is shown stored on server 302. Also shown in exemplary environment 300 is network 312. Network 312 is analogous to WAN 102 in FIG. 1.

Optimized solution generation engine 304 is a computer program or system comprised of multiple modules for carrying out the inventive approach. Shown operational on Optimized solution generation engine 304 is Optimization issue solution verification module 306, random solution generation module 308 and decision solution model generation module 310. Optimized solution generation engine 304 can transform the constraints and objective function of an optimization problem contained in a solution verification program into a decision solution optimization model using random solutions labeled by the optimization issue solution verification program. In an embodiment, optimized solution generation engine 304 may have a generative artificial intelligence capability (not depicted) trained to parse optimization issue data 320 to generate a verification solution program with components identified from optimization issue data (described further below).

In an embodiment, optimized solution generation engine 304 can manage the administration of labeling random solutions generated by random solution generation module 308 and input into optimization issue solution verification module 306 for verification and labeling (described further below).

Optimization issue solution verification module 306 is a computer program that can receive decision variables as input and determine whether the decision variables satisfy the constraints of an optimization issue and calculate an objective value for the input decision variables. In other words, optimization issue solution verification module 306 operates a verification program for the optimization issue. In an embodiment, optimization issue solution verification module 306 can be a program written in python coding language that contains the constraints and objective function for an optimization issue. In another embodiment, optimization issue solution verification module 306 can be a spreadsheet program (e.g., Microsoft® Excel, Google® sheets, etc. . . . ) that can receive as input one or more decision variables associated with an optimization problem and determine if the constraints of the optimization issue are satisfied and calculate an objective value for the decision variables.

In an embodiment, Optimization issue solution verification module 306 is can be written in a programming language, such as python, by a human programmer. In another embodiment, optimization issue solution verification module 306 can be written in python programming language by a generative artificial intelligence model using optimization issue data 320 stored on server 302. For example, a generative artificial intelligence model may be trained to parse the optimization issue data 320 and identify constraints and objectives associated with the data type and transform qualitative data into quantitative data. Further, optimization solution verification module 306 may be a program generated by a generative artificial intelligence model and modified by a human programmer to incorporate specific constraints and decision variables or objectives.

In an embodiment, optimization issue solution verification module 306 can label an input solution of decision variable. For example, optimization issue solution verification module 306 can receive a solution consisting of decision variables. Initially, the verification programs check the decision verification to ensure the constraints are satisfied. If the one or more of the constraints are not satisfied, the program can provide a value determining how far the solution is from satisfying the constraint and the program labels the solution a “fail” or equivalent terminology. If the one or more of the constraints are not satisfied, the program calculating the objective value and the program labels the solution a “fail” or equivalent terminology. The verification program may perform a combination of either of the immediate examples for inputs which fail have constraints which do not satisfy the objective. If all of the constraints are satisfied, the program labels the solution as “pass” and calculates an objective value for the solution. The label can be a token or metadata associated with the solution or it can be inserted into a table in a spreadsheet program.

Random input generation module 308 is a computer module that can generate solutions to the optimization issue. The generated solutions can be generated at random in a format which is compatible with sequence generation model. In an embodiment, the solutions generated by random solution generation module 308 are the values of the decision variables which are input into optimization solution verification module 306 for labeling. The decision variables can be numerical values or qualitative in nature. In an embodiment, numerical values can be set within a predetermined range either manually by a user or random solution generation module can analyze the optimization issue solution verification module to determine a range for each variable within a specific error range, (e.g., 1%, 5%, 10%, etc. . . . ). Random solution generation module 308 can set a batch size of random solutions which can be generated for the optimization issue.

Decision solution generation module 310 is a computer program or system that can administer the training and operation of a deep learning model. In an embodiment, decision solution generation module 310 can receive the generated random solutions labeled by optimization issue solution verification module 306. This comprises a dataset which is used to train a solution generating sequence model. In an embodiment, Decision solution generation module 310 can prepare and initialize a general purpose transformer-based deep learning model and perform the process of training the transformer-based deep learning model through multiple iterations of training until a predetermined number of iterations is reached or until a satisfactory error value is reached, using an algorithm such as policy gradient reinforcement learning.

In an embodiment, decision solution generation module 310 can parse the code (i.e., program code) of the optimization solution verification program associated with optimization issue solution verification module 306 to translate or convert the code into a loss function incorporating the objectives and constraints of the code. For example, based on program code an optimization problem formulation can be x*∈arg min_{x∈χ∩Ω(p)}f(x, p). The formula can be extracted from an optimization solution verification program. The formulation can be used as the loss function to train a sequence generation model. In an embodiment, the optimization problem formulation x*∈arg min_{x∈χ∩Ω(p)}f(x, p) can be extracted to fine-tune a pretrained or general use sequence generation model.

In another embodiment, decision solution generation module 310 can administer the fine-tuning of a deep learning model (e.g., transformer-based) previously trained to generate an optimized solution to a similar optimization issue (e.g., energy use in a hospital vs energy use in a water sanitation plant where both facilities are essential and open 24 hours a day, yet experience different energy requirements). In this embodiment, the fine-tuning starts from the weights of the pre-existing deep learning model, and, using the loss function derived from the objectives and constraints of the new problem, updates all or some of the weights by retraining. This embodiment has numerous advantages or existing methods in that it is more time efficient and consumes less computational and energy resources.

In yet another embodiment, decision solution generation module 310 can generate a solution generating sequence model with custom architecture (e.g., a deep learning model), based on the optimization issue at hand. For example, decision solution generation module 310 can analyze the compiled labeled data set and determine the number transformers and attention mechanism to efficiently and accurately generate an optimization solution based on the number and type of constraints and decision variables. The generated custom solution generating sequence model can be initialized and trained using the labeled data set for a predetermined number of iterations or until a satisfactory error value is reached.

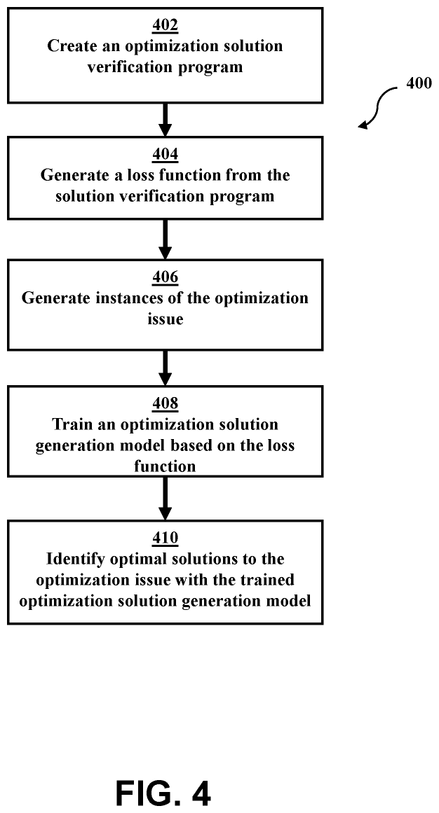

Now with reference to FIG. 4. FIG. 4 is flowchart 400 depicting steps to generate an optimized solution for an optimization problem, in accordance with an embodiment of the invention. At step 402, create an optimization solution verification program. The optimization solution verification program can be created by a user. The optimization solution verification program possesses a function for calculating the objective function value for a presented solution. Furthermore, the optimization solution verification program possesses a function for each constraint in an optimization issue. In an embodiment, if a solution is presented which does not satisfy a constraint, the constraint function can calculate the difference between the value associated with a solution and the value or range of values necessary to satisfy the constraint.

At step 404, generate a loss function based on the generated optimization solution verification program. In an embodiment, the loss function is generated incorporating the objective function calculation, and for each constraint, the constraint function from the verification program multiplied by a large coefficient. Therefore, the loss function incorporates the function for calculating the objectives, the constrains, and the function(s) for calculating the constrain.

At step 406, generate instances (input data) of the optimization issue.

At step 408, train an optimization solution generation model with the generated instances based on the generated loss function. In an embodiment, the loss function can be utilized to train the optimization solution generation model using the generated instances as training data in a reinforcement learning algorithm. Multiple iterations of training can be performed until a satisfactory value is generated.

At step 410, find optimal solutions to the optimization issue based on the trained optimization solution generation model. For example, optimization solution issue data can be used as input to the trained optimization solution generation model. The trained optimization solution model can then generate one or more good solutions (in terms of a loss function value) to the optimization problem. In an embodiment, parameters of the optimization solution generation model can be changed or updated to obtain a better loss function value for specific instances or input data, for example, to satisfy constraints for this specific instance which were violated by the original trained model.

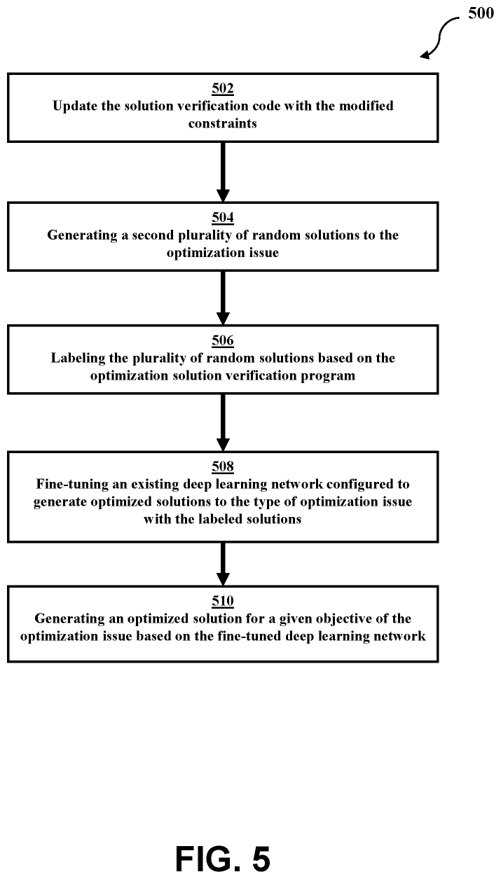

Now with reference to FIG. 5. FIG. 5 is flowchart 500 depicting steps to fine-tune an existing or prior trained decision generation model (i.e., a sequence generation model) in response to updated constraints and conditions in an optimization issue, in accordance with an embodiment of the invention. At step 502, update an optimization solution verification program. In an embodiment, optimized solution generation engine 304, can generate or update a solution verification code (e.g., python) in which the constraints and objective function of the optimization issue are presented. In another embodiment, an excel program may be generated which contains the problem details including the constraints and objective function. In an embodiment, optimization issue solution verification module 306 may be a pre-existing program that can be modified by a user or Cognitive (e.g., artificial intelligence program, machine learning model) program to include the conditions, constraints, decision variables, and objective function of the optimization issue.

At step 504, convert or translate the updated optimization solution verification program into an updated loss function which incorporated the updated objectives and constraints of the optimization issue. In an embodiment, decision solution generation model generation model generation module 310 can convert or translate the updated program code of the optimization solution verification program of optimization issue solution verification module 306 into a loss function. In an embodiment, the loss function will encompass and contain the constraints and the desired objectives of the optimization issue.

At step 506, generate a second set of random inputs for a sequence generation model associated with the optimization issue. In an embodiment, random input generation module 308 can produce random inputs compatible with the updated solution verification program and sequence generation model. For example, the ranges associated with the decision variables can be updated based on an analysis of the ranges corresponding to the updated solution verification program.

At step, 508, fine-tune an existing sequence generation model configured to generate optimized solutions to the type or kind of optimization issue with the labeled second set of randomly generated solutions. In an embodiment, decision solution model generation module 310 can select a sequence generation model pre-trained to a similar type or class of optimization issue and fine-tune the model using an updated loss function based on the constraints, conditions, and objective function of the subject optimization issue, with the labeled random inputs, based on the updated loss function and the labeled.

At step 510, the sequence generation model can generate an optimized solution for the optimization issue. The trained sequence model can output one or more decision optimized variables which correspond to the desired objective for the optimization issue.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating optimization solutions, the computer-implemented method comprising:
generating an optimization solution verification program, wherein the optimization solution verification program determines if an input satisfies one or more constraints associated with an optimization issue and responsive to the input satisfying the one or more constraints, calculate a value for the input associated with an objective function based on the one or more constraints;
converting automatically, by the processor, a program code of the optimization solution verification program into a loss function incorporating the objective function calculation and constraint satisfaction;
generating, by the processor, a plurality of random inputs to the optimization issue;
training, by the processor, a sequence generation model with the loss function and the plurality of random inputs; and
generating, by the processor, an optimized solution for the optimization issue based on the trained sequence generation model.

2. The computer-implemented method of claim 1, further comprising;
updating, by the processor, the program code with one or more additional constraints and/or updated objectives; and
updating the loss function and retraining the model.

3. The computer-implemented method of claim 2, further comprising:
labeling, by the processor, a second set of random solution, based on the updated program code; and
tuning, by the processor, the sequence generation model based on the labeled second set of random solutions.

4. The computer-implemented method of claim 1, wherein the generated optimized solution for the optimization issue is a set of decision variable values, wherein the decision variable values provide an optimized objective value when applied to the objective function within a domain space for the optimization issue, and in which these inputs and solutions generated by the optimized value and satisfying the constraints are used to tune the sequence generation model in a supervised manner.

5. The computer-implemented method of claim 1, wherein the optimization solution verification program is based on python programming language code.

6. The computer-implemented method of claim 1, wherein the optimization solution verification program is a spreadsheet based program configured to receive one or more decision variables of the optimization issue as input.

7. The computer-implemented method of claim 1, wherein the sequence generation module is a transformer based deep learning network.

8. A computer system for generating optimization solutions, the computer system comprising:
a processor;
a memory; and
program instructions stored on a storage device, the program instructions executable by the processor to perform one or more operations, the operations comprising:
generate an optimization solution verification program, wherein the optimization solution verification program determines if an input satisfies one or more constraints associated with an optimization issue and responsive to the input satisfying the one or more constraints, calculate a value for the input associated with an objective function based on the one or more constraints;
convert automatically, by the processor, a program code of the optimization solution verification program into a loss function incorporating the objective function calculation and constraint satisfaction;
generate a plurality of random inputs to the optimization issue;
train a sequence generation model with the loss function and the plurality of random inputs; and
generate an optimized solution for the optimization issue based on the trained sequence generation model.

9. The computer system of claim 8, further comprising program instructions to:
update the program code with one or more additional constraints and/or updated objectives; and
update the loss function and retraining the model.

10. The computer system of claim 9, further comprising program instructions to:
label a second set of random solution, based on the updated program code; and
tune the sequence generation model based on the labeled second set of random solutions.

11. The computer system of claim 8, wherein the generated optimized solution for the optimization issue is a set of decision variable values, wherein the decision variable values provide an optimized objective value when applied to the objective function within a domain space for the optimization issue, and in which these inputs and solutions generated by the optimized value and satisfying the constraints are used to tune the sequence generation model in a supervised manner.

12. The computer system of claim 8, wherein the optimization solution verification program is based on python programming language code.

13. The computer system of claim 8, wherein the optimization solution verification program is a spreadsheet based program configured to receive one or more decision variables of the optimization issue as input.

14. The computer system of claim 8, wherein the sequence generation module is a transformer based deep learning network.

15. A computer program product for generating optimization solutions, the computer program product comprising program instructions stored on a storage device, the program instructions executable by a processor to cause the processors to perform operations to:
generate an optimization solution verification program, wherein the optimization solution verification program determines if an input satisfies one or more constraints associated with an optimization issue and responsive to the input satisfying the one or more constraints, calculate a value for the input associated with an objective function based on the one or more constraints;
convert automatically, by the processor, a program code of the optimization solution verification program into a loss function incorporating the objective function calculation and constraint satisfaction;
generate a plurality of random inputs to the optimization issue;
train a sequence generation model with the loss function and the plurality of random inputs; and
generate an optimized solution for the optimization issue based on the trained sequence generation model.

16. The computer program product of claim 15, further comprising program instructions to:
update the program code with one or more additional constraints and/or updated objectives; and
update the loss function and retraining the model.

17. The computer program product of claim 16, further comprising program instructions to:
label a second set of random solution, based on the updated program code; and
tune the sequence generation model based on the labeled second set of random solutions.

18. The computer program product of claim 15, wherein the generated optimized solution for the optimization issue is a set of decision variable values, wherein the decision variable values provide an optimized objective value when applied to the objective function within a domain space for the optimization issue, and in which these inputs and solutions generated by the optimized value and satisfying the constraints are used to tune the sequence generation model in a supervised manner.

19. The computer program product of claim 15, wherein the optimization solution verification program is based on python programming language code.

20. The computer program product of claim 15, wherein the optimization solution verification program is a spreadsheet based program configured to receive one or more decision variables of the optimization issue as input.
